(19) United States
(12) Patent Application Publication
(10) Pub. No.: US 2024/0162555 A1
(43) Pub. Date: May 16, 2024

(54) HYBRID COMPRESSION PAD FOR A BATTERY CELL STACK AS WELL AS MANUFACTURING METHODS THEREFOR, AND A BATTERY CELL MODULE CONSTRUCTED THEREWITH

(71) Applicant: Dr. Ing. h.c. F. Porsche Aktiengesellschaft, Stuttgart (DE)

(72) Inventor: Christian Porstendörfer, Stuttgart (DE)

(73) Assignee: Dr. Ing. h.c. F. Porsche Aktiengesellschaft, Stuttgart (DE)

(21) Appl. No.: 18/474,452

(22) Filed: Sep. 26, 2023

(30) Foreign Application Priority Data
Nov. 10, 2022 (DE) 10 2022 129 687.3

(51) Int. Cl. H01M 50/293; H01M 10/04; H01M 50/211; H01M 50/291

(52) U.S. Cl. CPC H01M 50/293; H01M 10/0481; H01M 50/211; H01M 50/291; H01M 2220/20

(57) ABSTRACT

A compression pad is provided for a battery cell stack. The compression pad includes a first material having a first compressive strength; a second material having a second compressive strength that is different than the first compressive strength. The compression pad includes at least one volume of the first material, which is at least partially surrounded by the second material with or without direct contact thereto. Furthermore, there is provided a method for manufacturing a compression pad, as well as a battery cell stack constructed on the basis of the compression pad.

### CROSS-REFERENCE TO RELATED APPLICATION

This application claims priority to German Patent Application No. 10 2022 129 687.3, filed Nov. 10, 2022, the content of such application being incorporated by reference herein in its entirety.

### FIELD OF THE INVENTION

The present invention relates to hybrid compression pads for a battery cell pack as well as to a manufacturing method therefor. Furthermore, the invention relates to a battery cell packet constructed on the basis of the hybrid compression pad.

### BACKGROUND OF THE INVENTION

The range of electric vehicles is largely determined by the traction battery installed therein. Today, appropriately sized high-voltage batteries are used in order to propel modern electric vehicles, which are made up of battery cell modules (also referred to as battery modules), each of which in turn contains a number of battery cells, each representing the smallest self-contained energy storage cell.

In general, in order to construct the battery modules, battery modules are used in which multiple cells are arranged in parallel, wherein a compression pad (also referred to as a compression insert or cell intermediate material) is respectively arranged between two cells. For increased cycle stability and longevity of the cells, they are strained with the compression pads. The prestressing is realized via pre-compression of the compression pads in the battery module. In addition, volume changes resulting from the so-called swelling can be balanced using the compressible compression pads. The compression behavior of compression pads can generally be divided into three paths: the prestressing path, which is necessary in order to build up a certain prestressing force on the cell; the working path, which serves to accommodate the volume change of the cell; and the residual block, which represents a nearly incompressible behavior after maximum compression.

Swelling is a volume change of a cell, in particular a lithium ion cell, which can be observed on the one hand during charging and discharging and on the other hand on a slower time scale due to the aging of the battery cell. Swelling is caused by a structural change of the active layers within the battery cell caused by the rearrangement of lithium ions occurring therein. Its extent is generally determined by the cell chemistry. By placing compression pads between the battery cells in the stacking direction as described above, they can compressively compensate for the volume change of the battery cells within a battery module.

Currently, foamed elastomers (or foam elastomers) are used for the manufacture of compression pads, which can be further divided into those having open and those having closed pores. Foam elastomers are characterized by a high compressibility compared to solid elastomers; however, as a result, no large prestressing forces can be applied thereby. One alternative to this is, for example, solid elastomers, as they have higher forces or voltages with the same compression rates. However, it is disadvantageous that they have no pores and thus cannot be compressed, so that their compressibility is limited by their transverse contraction.

EP3733511A1, which is incorporated by reference herein, discloses compression apparatuses for removable batteries, and in particular those that can be installed during transportation and charging of the battery in aircraft, such as aircraft wings, and that can be uninstalled prior to flight. The battery cells arranged in the battery case are fixed therein via prestressed spacers made from a foam material or a plastic material.

US2021257690A1, which is incorporated by reference herein, discloses a heat isolation element, which is designed in a sandwich-like manner and arranged between two battery cells adjacent to one another, wherein the two outer layers have a high thermal conductivity, and a porous intermediate layer arranged therebetween has a low thermal conductivity.

### SUMMARY OF THE INVENTION

Proceeding from the compression pads known from the prior art, described herein are compression pads for a battery cell module that eliminate or at least reduce the aforementioned issues with respect to the conflict of goals between high prestressing force with simultaneously low compression at the start of the life of the vehicle and high compressibility throughout the life of the vehicle.

In the compression pad, two materials having different mechanical properties are combined with one another. The mechanical property can in particular be a compressive strength, i.e. a differently strong deformation of the material upon application of a compressive force. By selectively blending (at least) two materials with different compressive strengths, compression pads can be provided that have optimized properties with respect to their use. Thus, at least one volume of a first material, e.g. an elastomer, having a particular surface ratio is used in order to set a prestress of the compression pad in the desired range of values. A second material, e.g. a foam, such as elastomeric foam, represents a material at least partially surrounding the at least one volume of the first material, thus allowing for a transverse expansion of the elastomer. The second material can fill in a cavity around the at least one volume of the first material and can thus determine the resistance force of the surrounding medium to the transverse expansion of the first material into this space, which is then filled with the second material. By selecting the material parameters of the first and second materials in a targeted manner, the overall stiffness of the compression pad according to aspects of the invention can be adjusted.

The combination of the two materials is not a mixture of the materials at the molecular level, such as an alloy, but rather a blending of differently sized volumes or domains of a first material and a second material, wherein the volumes have a dimension in the range of a few centimeters to tens of centimeters. Each of the volumes itself represents a contiguous region of the first or the second material.

According to aspects of the invention, there is provided a compression pad for a battery cell stack comprising a first material having a first compressive strength and a second material having a second compressive strength that is different than the first compressive strength. For example, the second compressive strength can be less than the first compressive strength. The compression pad comprises at least one volume of the first material, which is at least partially surrounded by the second material with or without direct contact thereto. In other words, the second material can directly abut the at least one volume of the first material, or there can be a free space between the at least one volume of the first material and the second material, which can be filled for example with air. Among other things, the surrounding of the at least one volume of the first material by the second material can be understood to mean that, when the compression pad according to aspects of the invention is viewed in the lateral cross-section, the second material is arranged axially about the at least one volume of the first material (at a distance) or on the at least one volume of the first material (with direct contact). In such a configuration of the compression pad according to the present invention, the at least one volume of the first material can, in case of lateral application of pressure, absorb the resulting force, because the axially surrounding second material allows its transverse expansion. With regard to the intended use of the compression pad according to aspects of the invention in a battery cell stack, the lateral direction of the battery cells would correspond to the stack direction. If necessary, the second material can also surround the at least one volume of the first material in the lateral direction, with or without direct contact thereto.

According to further embodiments of the compression pad according to the present invention, the second material can comprise a foamed elastomer. In principle, both soft-elastic foamed elastomers (soft foams) and hard-tough foamed elastomers (hard foams) can be used here. A thermoplastic, a thermosetting plastic, or an elastomer can be used as the starting material, for example polystyrene (PS), polypropylene (PP), polyvinylchloride (PVC), and polyurethane.

According to further embodiments of the compression pad according to the present invention, the first material can comprise an elastomer, in particular a solid elastomer. The first material, by contrast to the second material, is a non-foamed plastic, which, however, can be selected from the same group of starting materials as the second material.

According to further embodiments of the compression pad according to the present invention, wherein the compression pad can have multiple volumes of the first material, which are distributed in the second material. The second material can further surround the volumes of the first material with or without direct contact thereto. Also included herein are cases where the second material directly abuts the volumes of the first material in the axial direction and there is free space between the two materials in the lateral direction, or vice versa. The second material can serve as a carrier matrix in which bodies (volumes) from the first material are distributed.

According to further embodiments of the compression pad according to the present invention, the distribution density of the volumes of the first material in the second material can be inhomogeneous. By adjusting the distribution density, which can decrease, for example, from the center of the compression pad towards its axial ends, the stiffness profile of the compression pad can be adjusted to a desired specification profile. The distribution density can be varied by increasing or decreasing the number of consistent volumes of the first material and/or by increasing or decreasing the volumes of the first material.

According to further embodiments of the compression pad according to aspects of the invention, the compression module can have a central region and adjacent side regions, wherein, in the central region, the distribution density of the volumes of the first material in the second material is greater than in the side regions. The side regions can correspond to axial regions of the compression pad.

According to further embodiments of the compression pad according to aspects of the invention, the volumes of the first material can have a straight-line shape. For example, the volumes can be rods or cylinders.

According to further embodiments of the compression pad according to aspects of the invention, the volumes of the first material can have an arc-like shape. For example, the volumes can be semi-circular or can have a semi-elliptical shape.

According to further embodiments of the compression pad according to the present invention, the first material can be arranged in at least one free space within the compression pad. The at least one free space can extend perpendicular to the axial direction of the compression pad and can provide space for expansion of the first material as it expands due to compression by the expanding adjacent battery cells.

According to aspects of the invention, there is further provided a method for manufacturing a compression pad for a battery cell stack. The method comprises the step of providing at least one volume of the first material having a first compressive strength and providing a second material having a second compressive strength that is less than the first compressive strength. The method further comprises the step of forming the compression pad by introducing the at least one volume of the first material into the second material in such a way that the volume of the first material is at least partially surrounded by the second material with or without direct contact thereto.

According to further embodiments, the method for manufacturing can further comprise the step of adjusting the stiffness of the compression pad by adjusting the shape and/or the number and/or the distribution of volumes of the first material in the second material. This step can be preceded by a planning phase in which the deformation behavior is calculated based on a model of the compression pad based on known material parameters. For example, a Finite Element Method (FEM) can be used for this purpose.

According to the present invention, there is further provided a battery cell stack comprising an arrangement of individual battery cells, wherein a respective compression pad according to any one of the preceding embodiment examples is arranged between two respective battery cells.

In principle, the compression pad according to aspects of the invention can be used in order to construct a battery cell stack based on any desired battery cells, for example pouch or prismatic battery cells. Pouch battery cells have a soft outer shell, while prismatic battery cells have a relatively stiff housing. Advantageously, the stiffness or compressive strength of the compression pad according to aspects of the invention as a whole can be adapted to the respective mechanical properties of the different battery cells by the selection of the first and second materials and/or by the geometric arrangement of the materials within the compression pad.

It goes without saying that the aforementioned features and the features yet to be explained in the following can be used not only in the respectively specified combination, but also in other combinations or on their own, without leaving the scope of the present invention.

### BRIEF DESCRIPTION OF THE DRAWINGS

Additional advantages and configurations of the invention result from the description and the enclosed drawings.

FIG. 1 illustrates the swelling behavior in battery cells.

FIGS. 2A and 2B show diagrams illustrating the qualitative behavior of two materials having different compressive strengths.

FIGS. 3A and 3B show the dynamic behavior of an embodiment example of the compression pad according to aspects of the invention.

FIGS. 4A and 4B show different basic structures of an exemplary compression pad according to aspects of the invention.

FIG. 5 illustrates a further exemplary basic structure of the compression pad according to the present invention

FIGS. 6A and 6B show further different basic structures of an exemplary compression pad according to the present invention.

FIG. 7 shows further basic structures of an exemplary compression pad according to the present invention.

### DETAILED DESCRIPTION OF THE INVENTION

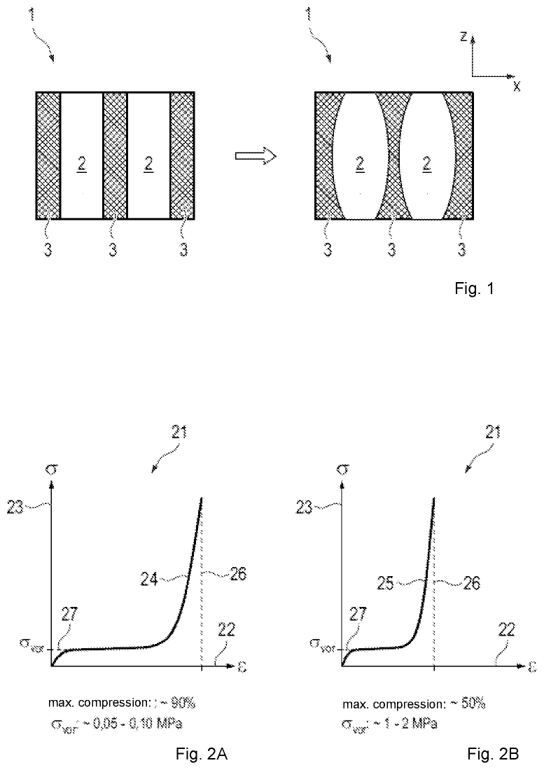

In FIG. 1, the swelling behavior is illustrated on the basis of a highly simplified battery cell stack 1. The battery cell stack is shown in a lateral cross-sectional view and comprises two battery cells 2. Each battery cell 2 laterally abuts a compression pad 3. On the left-hand side, the battery cell stack 1 is not affected by the swelling. Charging and aging of the battery cells 2 causes a swelling of the battery cells 2, which is illustrated in the battery cell stack 1 on the right-hand side. The compression pads 3 arranged between the battery cells 2 are compressed accordingly. The coordinate system in FIG. 1 and also in all further figures, where applicable, characterizes certain spatial directions. The z-axis refers to the direction designated as the axial direction in the following. The stacking direction of the battery cells 2 in a battery cell stack 1 is the x-direction.

FIGS. 2A and 2B show compressive stress/bulging diagrams illustrating the qualitative behavior of two materials having different compressive strengths. In both cases, the bulging or compression c is shown on the x-axis 22 and the compressive stress a is shown on the y-axis. In both diagrams, the curves 24, 25 have a generally similar profile, but this differs with regard to quantitative aspects.

The curve 24 in FIG. 2A shows the stress profile in a compressive deformation of a foam. A foam is easily compressible and can also be compressed up to 90% of its original dimension, wherein this value corresponds to the asymptotic limit value 26 of the curve 24. In case of foaming, the pronounced plateau region of the curve 24 typically starts at values 27 in the range of 0.02-0.10 MPa. This value 27 can be considered a prestress σₚᵣₑ. A foam is relatively soft and therefore, when formed into a compression pad, cannot absorb a large prestress σₚᵣₑ as such.

The curve 25 in FIG. 2B shows the stress profile in case of a compressive deformation of an elastomer. An elastomer has a much lower compressibility compared to the foam and can only be compressed to about 50% of its original dimension, wherein this value corresponds to the asymptotic limit value 26 of the curve 25. However, in elastomers, the less pronounced plateau region of the curve 24 typically arises in case of values 27 in the range of 1-2 MPa, which are thus one order of magnitude above the corresponding typical values 27 of foams. Thus, an elastomer is relatively solid and, when formed into a compression pad, can absorb higher forces or voltages. As mentioned above, however, the compressibility of elastomers is limited by their transverse contraction, as they have no pores and thus cannot be compressed.

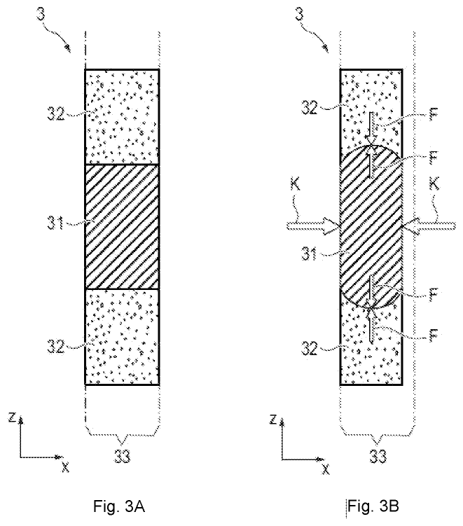

In FIGS. 3A and 3B, an embodiment example of the compression pad 3 according to aspects of the invention is shown in a cross-sectional view. It comprises an interior volume 31 of the first material, an elastomer, and adjacent end regions 32 comprising the second material, a foam. The second material is axially distributed around the first material or arranged so as to axially abut it. In the initial state, in which no forces act on the compression pad 3, it has a lateral dimension 33.

Because solid elastomers are non-porous, they are limited in their compressibility by transverse contraction. The approach according to aspects of the invention is to create regions into which the elastomer can expand in order to achieve the desired behavior of the compression pad 3. To this end, the material parameters of the two materials, such as the degree of filling or porosity in the case of foam elastomers and the Shore Hardness in the case of solid elastomers, can be matched to one another. The material parameters also influence the overall stiffness of the compression pad 3.

As illustrated in FIG. 3B, a lateral compressive force K results in the compression pad 3 bulging overall, wherein the volume 31 of the first material expands into the regions of the second material 32 due to its greater compressive strength. At the same time, the lateral dimension 33 of the compression pad 3 decreases. The compressive force K is exerted from battery cells abutting both sides of the compression pad 3. The stacking direction, i.e. the alternating arrangement of the battery cell and the compression pad, extends in the sheet plane, i.e. in the x-direction according to the coordinate system shown.

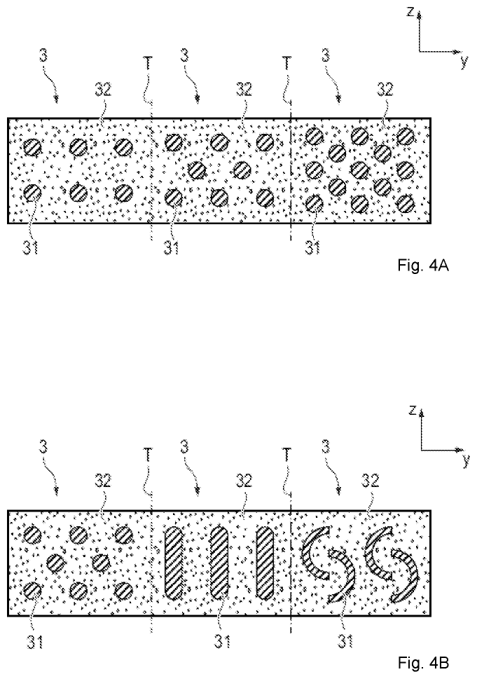

FIGS. 4A and 4B show different basic structures of an exemplary compression pad 3 according to the present invention. A selection of conceivable basic structures (with no assumption of being exhaustive) are shown in a row and are separated from one another by vertical dashes T. When using corresponding compression pads in a battery cell stack, the stacking direction would be in the x-direction, that is to say perpendicular to the yz-plane according to the coordinate system shown.

In FIG. 4A, the first material is provided in the form of cylindrical or rod-shaped volumes 31 and is embedded in the second material 32. The distribution density of the volumes 32 in the second material 32 increases from left to right. This can be adjusted as desired in order to obtain a desired overall stiffness of the compression pad 32. By adjusting the surface ratio of the elastomer, a desired prestressed region of the compression pad 3 can be set. As the battery cells expand, a pressure is applied to the volumes 31 of the first material, which thereby bulge along their longitudinal expanse (into the sheet plane).

As shown in FIG. 4B, in order to adjust the dynamic behavior of the compression pad 3 according to aspects of the invention, the shape of the volumes 31 of the first material within the second material 32 can also be changed. In the basic structure shown on the left-hand side, the volumes 31 are circular or cylindrical (as shown in FIG. 4A). In the basic structure shown in the middle, the volumes 31 are plate-shaped (rod-shaped in the view shown). In the basic structure shown on the right-hand side, the volumes 31 of the first material are semi-tubular (semi-annular in the view shown). The shapes shown are merely exemplary, and numerous other shapes are possible.

In principle, a variety of different arrangements of the second material in the first material is conceivable. Only simple basic structures are shown in FIGS. 4A and 4B, wherein more complex geometries can of course also be used. In the design of a compression pad according to aspects of the invention, the following five factors for its final structure can be considered: cell type (e.g. pouch, prismatic), swelling characteristics (strength of the “bulging” of the cells used), cell or cell intermediate material dimension, desired behavior in case of compression (e.g. compressive strength profile on the contact surface to the cell), compressive paths to be absorbed as a function of the force acting on the compression pad.

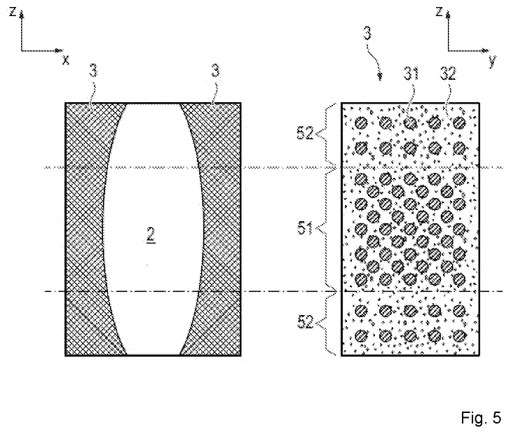

FIG. 5 shows a further exemplary basic structure of the compression pad 3 according to aspects of the invention, which has an axially changing distribution density of the volumes 31 of the first material within the second material 32. As illustrated on the left-hand side of FIG. 5, the swelling behavior of a battery cell 2 is not uniform, but rather is stronger in the center of the battery cell 2 than in the margins. The compression pad 3 according to aspects of the invention, which is shown in FIG. 5 on the right-hand side in a view rotated by 90° about the z-axis, can be adapted to this behavior such that a first region 51 is provided in the center, in which the density of the first volumes 31 of the first material (i.e. the number of volumes 31, not the density of the first material itself) is greater than in the axially adjacent second regions 52. In further embodiments, the density can also decrease continuously towards the axial ends of the compression pad 3. Furthermore, the proportion of the first material can also be varied by changing the shape of the volumes 31 instead of or in addition to the number of volumes 31 (cf. FIG. 4B).

In the embodiment shown in FIG. 5, the first region 51, which corresponds to an interior region of the compression pad 3 according to aspects of the invention, is reinforced by the greater number per volume of the volumes 31 of the first material arranged therein compared to the second regions 52. In a further embodiment, however, the first region 51 can be purposefully designed so as to be softer than the second regions 52, for example by a smaller number per volume of the volumes 31 of the first material arranged therein.

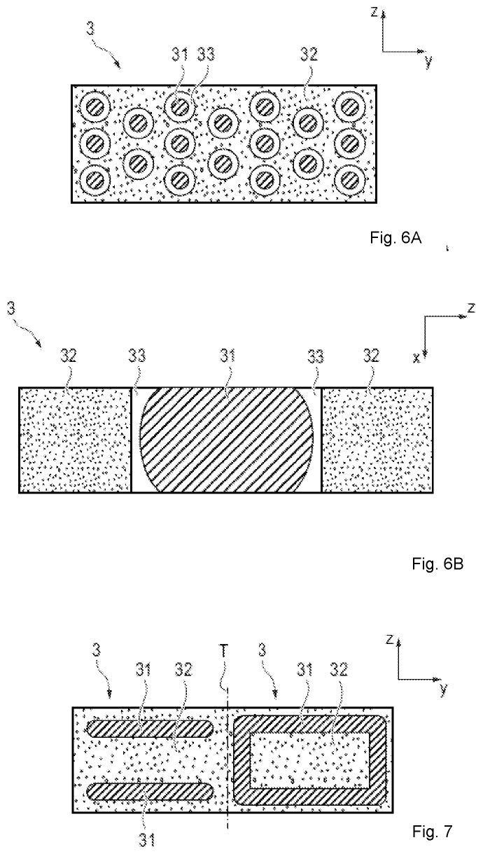

In FIGS. 6A and 6B, further different basic structures of an exemplary compression pad 3 according to aspects of the invention are shown in a top plan view, wherein the stacking direction extends perpendicular to the coordinate system y-z in the x-direction or perpendicular to the sheet plane. In FIG. 6A, an embodiment of the compression pad 3 is shown, in which rod-shaped volumes of the first material 31 are embedded in the second material 32. Additionally, a free space 33 is provided around each volume of the first material 31, or each volume 31 is arranged in a corresponding free space 33. The free spaces 33 can be filled with air. When pressure is applied to the rod-shaped volumes 31, they bulge and can expand undisturbed into the surrounding free space 33. In the example shown, the free spaces 33 are arranged concentrically around the rod-shaped volumes 31, but this is not absolutely necessary. The free spaces 33 can also have an elliptical or rectangular cross-section.

The principle illustrated on the basis of FIG. 6A can be applied to any other basic shape of the compression pad shown in the FIGS., such that, between the volumes of the first material 31 and the second material 32, a free space 33 can be provided, which creates a distance between them.

In FIG. 6B, an embodiment of the compression pad 3 based on the concept shown in FIG. 6A is shown, in which a respective free space 33 is arranged between the volume of the first material 31 and portions of the second material 32 arranged axially around the first volume 31. The compression pad 3 is shown here in a bulged form by a compressive force K acting thereon laterally. Due to the free space 33, there is no interaction between the two materials, or there is interaction that occurs only in the case of extreme transverse contraction, whereby the behavior of the compression pad 3 can be well predicted.

In FIG. 7, two further basic structures of an exemplary compression pad 3 according to aspects of the invention are shown in the top plan view, wherein they are separated by a vertical dash T. Here, the stacking direction when installing the compression pads 3 would be perpendicular to the coordinate system y-z in the x-direction or perpendicular to the sheet plane.

In the embodiment shown on the left-hand side in FIG. 7, the first material 31 is present in the form of two plates (in cross-section, these look rod-shaped) which are arranged in the upper and lower region of the compression pad 3 in the second material 32. The arrangement of the two plates can be rotated by 90° so that they are arranged laterally in the compression pad 3, not at the top and bottom. By means of the plates, prestressing forces can be specifically applied.

Another way to selectively apply the desired prestressing force is shown on the right-hand side in FIG. 7. Here, the first material 31 is provided in the form of a frame embedded in the second material or a substantial portion thereof. The second material 32 located in the center of the compression pad is thereby only slightly strained in the initial production process of a corresponding high-voltage battery and can consequently provide a majority of its compressibility for compensation of the swelling.

As already mentioned, the volumes of the first material 31 shown in FIG. 7 in particular can also be embedded in a free space instead of in direct contact with the second material 32.

What is claimed is:

1. A compression pad for a battery cell stack, said compression pad comprising:
a first material having a first compressive strength;
a second material having a second compressive strength that is different than the first compressive strength;
wherein at least one volume of the first material is at least partially surrounded by the second material with or without direct contact thereto.

2. The compression pad according to claim 1, wherein the first material comprises an elastomer.

3. The compression pad according to claim 1 wherein the second material comprises a foamed elastomer.

4. The compression pad according to claim 1, wherein the compression pad comprises multiple volumes of the first material, which are distributed in the second material.

5. The compression pad according to claim 4, wherein a distribution density of the multiple volumes of the first material in the second material is inhomogeneous.

6. The compression pad according to claim 5, wherein the compression pad comprises a central region and adjacent side regions, wherein, in the central region, the distribution density of the multiple volumes of the first material in the second material is greater than in the side regions.

7. The compression pad according to claim 4, wherein the multiple volumes have a straight-line shape.

8. The compression pad according to claim 4, wherein the multiple volumes have an arc shape.

9. The compression pad according to claim 1, wherein the first material is arranged in at least one free space within the compression pad.

10. A battery cell stack comprising:
an arrangement of individual battery cells in pouch cell format, and
the compression pad according to claim 1 arranged between two respective battery cells.

11. A battery comprising the battery cell stack according to claim 10.

12. A vehicle comprising the battery of claim 11.

13. A method for manufacturing a compression pad for a battery cell stack, said method comprising:
providing at least one volume of a first material having a first compressive strength;
providing a second material having a second compressive strength that is less than the first compressive strength; and
forming the compression pad by introducing the at least one volume of the first material into the second material in such a way that the at least one volume of the first material is at least partially surrounded by the second material with or without direct contact thereto.

14. The method according to claim 13, further comprising adjusting a stiffness of the compression pad by adjusting a shape and/or a number and/or a distribution of volumes of the first material in the second material.
